(19) United States
(12) Patent Application Publication
(10) Pub. No.: US 2012/0205564 A1
(43) Pub. Date: Aug. 16, 2012

(54) FLUID ACTUATED VALVE AND INSTALLATION TOOL

(76) Inventors: Jeffrey F. Klein, Glen Burnie, MD (US); Konstantin Mikhailov, Pasadena, MD (US)

(21) Appl. No.: 13/503,034

(22) PCT Filed: Oct. 22, 2010
(86) PCT No.: PCT/US2010/053684

§ 371 Date: Apr. 20, 2012

Related U.S. Application Data
(60) Provisional application No. 61/279,552, filed on Oct. 22, 2009.

(51) Int. Cl. F16K 21/12; B23P 19/04

(52) U.S. Cl. 251/15; 29/213.1

(57) ABSTRACT

A fast-action direct-fluid (gas or liquid) actuated valve assembly including a valve housing having an internal fluid port defined by a larger chamber and a smaller chamber, separated by a shoulder, a valve body seated in the valve housing and defined by a plurality of ports evenly spaced circumferentially around its circumference adjacent to an endplate seatable in the housing, a plurality of supporting wall sections (mullions) between the ports, and a plurality of internal vanes 9 each running along a corresponding mullion providing reinforcement thereof. The vanes 9 are inclined and/or curved, and defined by rounded faces to promote a smooth circular internal fluid flow. A valve cap formed with an annular collar is affixed to the valve body, and the valve body 2 and cap/collar 7 are slidably carried in the valve housing 1 between an open position and a closed position. A toolset is also disclosed for easily installing and removing the valve assembly.

### CROSS-REFERENCE TO RELATED APPLICATION(S)

The present application derives priority from U.S. provisional patent application Ser. No. 61/279,552 filed 22 Oct. 2009.

### BACKGROUND OF THE INVENTION

1. Field of the Invention

The present invention relates to valves and, more particularly, to a fluid (hydraulic or pneumatic) actuated valve.

2. Description of the Background

Directly operated, or actuated, fluidic valves are well known in the art for controlling the flow of gas, air or fluid there through. Such valves typically include a valve body having a flow passage formed through the valve body. A valve member is supported within the flow passage and moveable from one position to another to regulate fluid flow in direct response to an operative force placed on the valve member by an actuator. A plurality of ports are provided to connect the valve assembly to a pressurized fluid supply as well as to the various active devices that the valve may control. The actuator is typically an electromagnetically or piezo-electric solenoid that is energized to move the valve member to a predetermined position within the flow passage. A return spring is often employed to bias the valve member back to a known non-energized position. Valves of this type are employed in a wide variety of manufacturing environments where high flow rates and fast response times are desired.

Exemplary of such valves is the fail-open solenoid actuated valve of William R. Hayes embodied in U.S. Pat. No. 5,413,308 (1995). The Hayes valve is a spring biased normally open solenoid actuated valve that includes a valve body having a valve seat defining a valve port located between an fluid inlet port and a fluid outlet port. A sealing member on a rod under the control of a spool is longitudinally moveable into our out of the valve port to control fluid flow. When the solenoid is de-energized, the valve spool is biased open by a compression spring. The sealing member contacts the inner valve seat when the solenoid is energized thus closing the valve. When the solenoid is deactivated intentionally or due to an electrical failure the valve fails to an open position.

Such valves are used in a wide variety of contexts ranging from engines to industrial systems to pneumatic tools. The operating parameters for such systems are growing increasingly stringent as designers attempt to make them faster, less expensive and lightweight. This places increasing demands on the valves used for such systems. Manufacturers now require control valves that can provide extremely fast positive shutoff, and turn on, within a few milliseconds. This speed is very difficult to achieve in a fluid valve.

Other examples of fluid control valves by the present inventors include a pneumatically actuated valve for internal combustion engines described in U.S. Pat. No. 7,140,332, issued Nov. 28, 2006 and an automatic, pressure responsive air intake valve for internal combustion engine described in U.S. Pat. No. 6,349,691 issued Feb. 26, 2002, each of which are incorporated herein by reference. U.S. Pat. No. 6,349,691 discloses an automatically actuated, pressure responsive air intake valve for an internal combustion engine generally having a fixed valve seat housing and a sliding valve member. The valve seat housing is threaded into the head of a working chamber on an internal combustion engine. The sliding valve member reciprocates through the housing in response to differential pressures on either side of the valve. The sliding member has a hollow chamber that opens in a sidewall of the valve seat housing, thereby directing a stream of air outward from the valve structure. U.S. Pat. No. 7,140,332, discloses a pneumatically actuated valve assembly for use as intake and/or exhaust valves on internal combustion engines. The assembly includes a valve, valve housing, and compressed gas distribution and timing mechanisms. The valve is comprised of a short light weight hollow cylindrical body with a capped lower end and an opened upper end. The valve is further defined by a plurality of ports adjacent to the lower end and a collar encircling the body adjacent the upper end. The valve housing is hollow and tubular having a larger diameter upper section and a smaller diameter lower section in which the valve slides up to close and down to open. The housing further includes hollow channels which direct compressed gas, managed by the distribution and timing mechanism, alternately towards the areas above and below the valve collar at regular intervals to open and close the valve, respectively.

### SUMMARY OF THE INVENTION

The object of the present invention is a direct fluid-actuated valve assembly that can provide extremely fast positive shutoff, and turn on, within a few milliseconds. The valve assembly includes a valve housing having an internal fluid port defined by a larger chamber and an adjacent smaller chamber demarcated by a shoulder, a valve body seated in the valve housing and defined by a plurality of ports evenly spaced circumferentially around its circumference a plurality of supporting wall sections (mullions) between the ports, and a plurality of internal vanes each running along a corresponding mullion for reinforcement thereof, said vanes being inclined and/or curved to promote a circular internal fluid flow within the valve body. A valve cap with annular collar is affixed to the valve body, and the valve body and cap/collar are slidably carried in the valve housing between an open position and a closed position.

A toolset is also disclosed for easily installing and removing the valve assembly. The toolset includes a valve wrench designed to mate with the collar and having an elongate handle for manual turning, and an open circular head defined by a plurality of interlocking features. The toolset also includes a chuck formed as an extended stem leading to a disk defined by a series of notches, the stem having a keyed cross-section, and the disk having notches conforming to the vanes of said valve body to grip the vanes and stabilize the valve body. The chuck protrudes up through the circular wrench head and can be held by a standard wrench, or other means, to stabilize the valve body while the valve wrench is turned to detach the collar.

### BRIEF DESCRIPTION OF THE DRAWINGS

FIG. 1 depicts the structural features of an exemplary pneumatically actuated valve according to the present invention.

FIG. 2 is an enlarged illustration of the valve body 2.

FIG. 3 is a top view of the valve body 2.

FIG. 4 is a cross-sectional perspective view of an assembled single acting valve body with valve body cap with collar affixed, seated in the valve housing in a closed position.

FIG. 5 is a cross-sectional perspective view of an assembled single acting valve body with valve body cap with collar affixed, seated in the valve housing in an open position.

FIG. 6 is a cross-sectional drawing of an assembled double acting valve according to the present invention in an open position.

FIG. 7 is a cross-sectional drawing of the double acting valve according to the present invention in a closed position.

FIG. 8 is an exploded view of a single acting valve according to the present invention inclusive of the valve wrench and chuck tools for installation and/or removal.

FIG. 9 is an enlarged side (A) and bottom (B) view of the chuck of FIG. 8.

### DETAILED DESCRIPTION OF THE PREFERRED EMBODIMENT

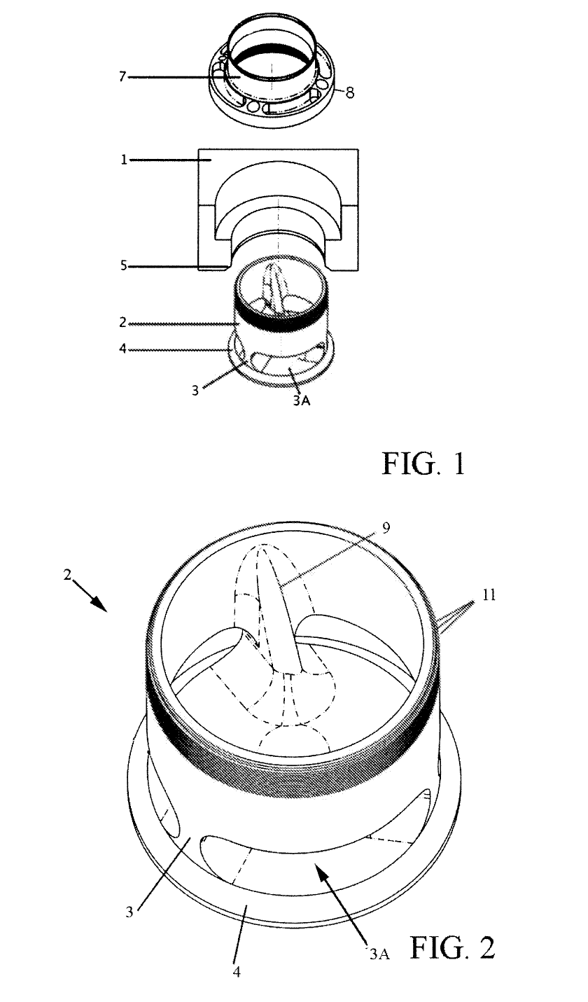

The present invention is a fast acting fluid actuated valve assembly. The invention is depicted in the context of a pneumatic valve directly actuated by means of forced or compressed air, although one skilled in the art will recognize that other pressurized gases or fluids may be suitable for actuating the valve of the present invention. With reference to FIG. 1, the structural features of an exemplary pneumatically actuated valve according to the present invention are depicted which generally include a valve housing 1, a valve body 2 seated in the valve housing 1 and having a cap 7 with annular collar 8 affixed to the valve body 2. The various components are described in more detail as follows.

As seen in FIG. 2, the valve body 2 is a hollow, cylindrical body with an upper end and a lower end. The lower end is capped by an endplate 4 forming a valve body seat that defines a floor to the valve body 2. The endplate 4 is beveled about the upper surface of its peripheral edge with a bevel of approximately 45 degrees to seat against a cooperative bevel in the valve housing 1. The endplate rises from the beveled peripheral edge 4 inwardly toward the center at an angle of between 0° and 25° degrees, inclusive, and preferably approximately a 10 degrees. The valve body 2 is further defined by a plurality of ports 3a around its circumference, adjacent the endplate 4. Preferably, three uniformly oblong ports 3a are provided at a uniform angular spacing, and all opening into the hollow interior of the valve body 2. The ports 3a are segregated by partitions or “mullions” 3 formed in the walls of the valve body 2. Each mullion 3 is relatively thin compared to the breadth of the ports 3a. The horizontal extent of each mullion 3 is approximately 15% that of each neighboring port 3a, such that the portion of the circumference occupied by the mullions 3 is 15% the total circumference of the valve body 2. This minimizes the obstruction by the mullions 3 and maximizes air/fluid flow through the ports 3a.

Under normal conditions, mullions 3 of this magnitude might be insufficient to support the endplate 4 under the operating stresses imposed on the valve. However, the mullions 3 are further defined by integral vanes 9 which extend internally into the valve body 2 and which add additional support. Each vane 9 originates proximate the upper end of the valve body 2 and terminates at endplate 4, running more or less lengthwise down a corresponding mullion 3. From top to bottom each vane 9 begins as a shallow inward protuberance and gradually ramps outward toward the bottom where it occupies, in certain embodiments, approximately 1/2 or more of the radius of the valve body 2. In addition, from proximate the valve body 2 wall to the innermost edge of the vane 9, each vane 9 adapts a slight angle to induce a circular air/fluid flow within the valve body 2. In further addition, each vane 9 runs top to bottom at a slight angular offset from vertical and mushrooms to a broader base at its juncture with endplate 4. The innermost edge of the vane 9 is rounded, all of the foregoing features contributing to proper airflow. The vanes 9 are preferably integrally molded to the valve body 2 and each vane 9 adds reinforcement to the mullion 3, preventing collapse. The valve body 2 is preferably threaded 11 externally around the upper end of the valve body 2 to affix the cap 7.

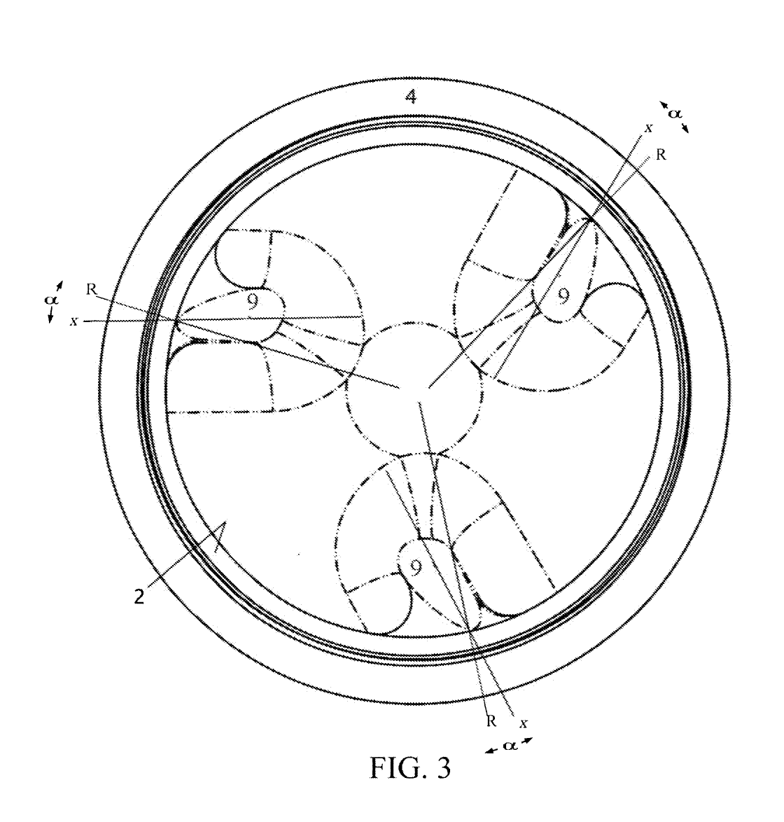

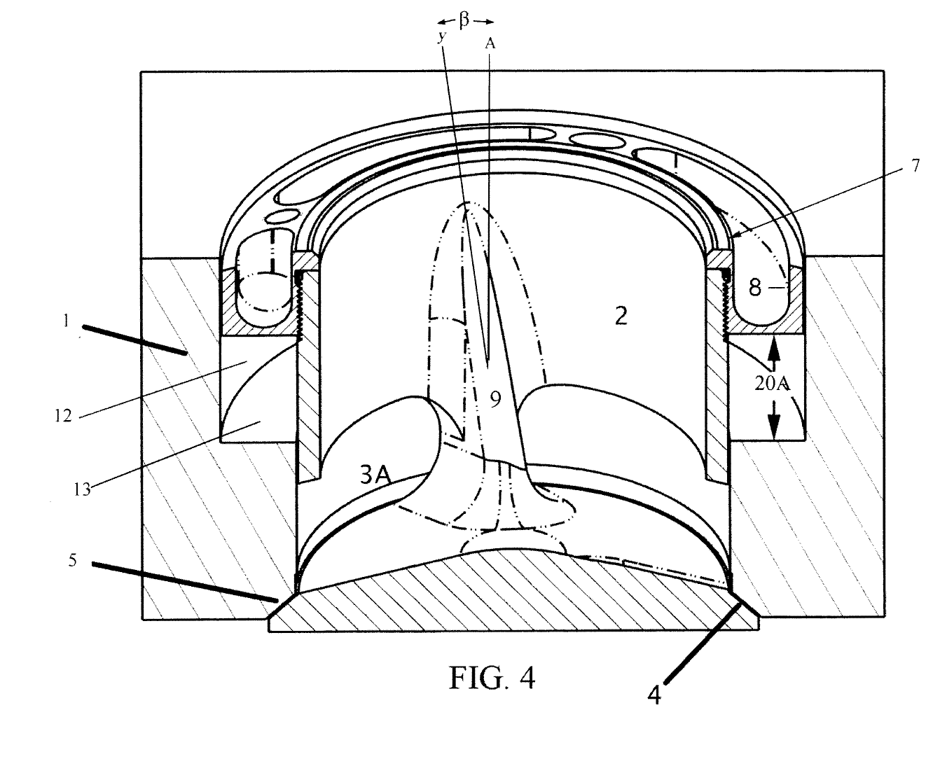

FIG. 3 is a top view of the valve body 2 illustrating the contour of each vane 9 provided in certain embodiments to induce a circular air/fluid flow within the valve body 2. The vanes 9 in such embodiments are each oriented radially inward along an axis x which is at an angle α of 10-15 degrees from the radial axis R of the valve body 2 (shown by angle lines). FIG. 4 is a cross-sectional perspective of the assembled valve body 2 seated in the valve housing 1, with valve body cap 7 (and integral collar 8) affixed to the valve body 2. The vanes 9 are each downwardly oriented along an axis y which forms an angle β of 10-15 degree offset from vertical axis A through the valve body 2. The combination of the x and β angular offsets, together with the rounded innermost edge of the vanes 9 and their broader contoured juncture with endplate 4 serves to deflect downward air/fluid flow laterally to induce a swirling circular air/fluid flow within the valve body 2.

The valve housing 1 may be any supporting structure, e.g., an engine block or cylinder head, made, machined, molded or otherwise formed with a suitable port for accepting the assembled valve body 2. The port is machined as a two-tiered cylindrical port with a larger upper diameter abutting a constricted lower diameter at a shoulder 13, the upper diameter defining a barrel for flush sliding of the valve body cap 7 and collar 8 (and valve body 2), and the barrel space between the shoulder 13 and the collar 8 defining a first “control volume” 20A. The shoulder 13 limits downward motion of the cap 7/collar 8 and body 2, and seats the valve body cap 7 and collar 8 when the valve is in the open (down) position.

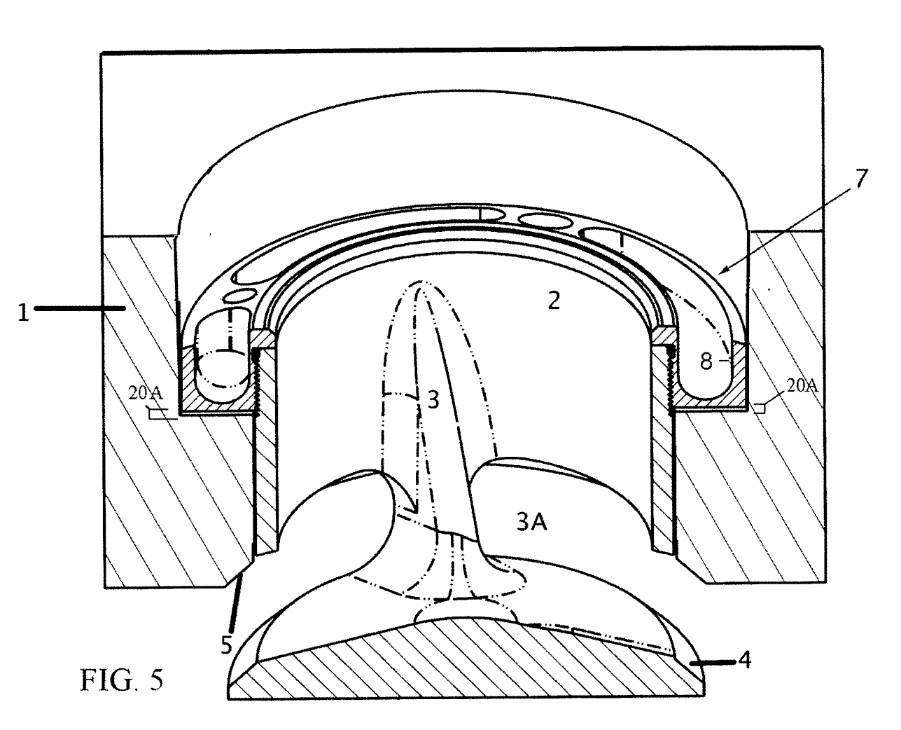

FIG. 5 illustrates the assembled valve body 2 and valve body cap 7 with collar 8 as in FIG. 4 seated in the valve housing 1, here in an open position. The valve body cap 7 with collar 8 (and valve body 2) slide downward until the collar 8 abuts the shoulder 13 in the port of valve housing 1, resulting in a minimal control volume 20A. This extends the endplate 4 beneath the valve body 1 opening the ports 3a for fluid flow (air, gas or liquid). Note that the first control volume 20A in FIG. 5 is near zero because the valve is shown in an open position, but the first control volume 20A increases as the valve closes. As noted, the lower rim 5 of the port in valve housing 1 is formed with a bevel to match that of the endplate 4 for flush seating of the valve body 2 against the valve housing 1 when the valve is in a closed position, as seen in FIG. 4. The overall length of the valve is relatively short and wide, compared to conventional direct valves which generally feature long thin bodies. The wide cylindrical valve body 2 of the present valve makes the valve less likely to suffer the effects of wear and tear as compared to conventional valves.

In a double or two-way acting embodiment of the present invention forced fluid such as compressed air or other gas is used to both open and close the valve. In this case there are two actuation areas, one above and one below the collar 8. The valve is closed by directing forced air below the collar 8, thereby exerting pressure to the underside of the collar 8 causing the valve to move upward and closed. For this purpose the embodiment shown in FIGS. 1-5 may additionally employ a housing cap 19 fixedly attached to the valve housing 1 to prevent withdrawal, as described below.

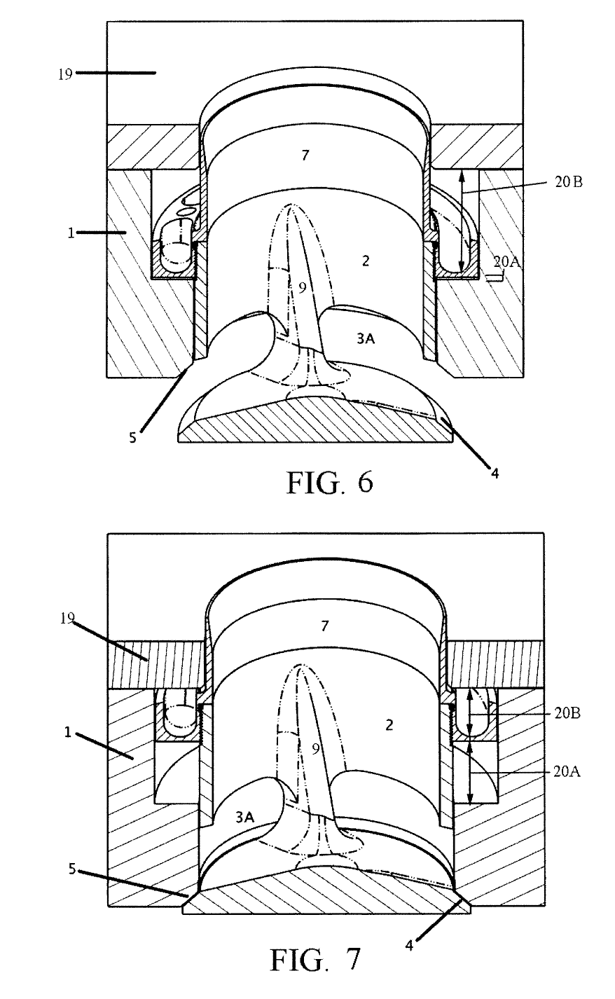

FIG. 6 is a cross-sectional drawing of an assembled two-way valve according to the present invention, in an open position while FIG. 7 shows the valve in a closed position. The housing cap 19 here is a solid wall attached to and covering the valve housing 1 but defined by an open aperture so as not to cover the open port. The inner cylindrical wall of the valve body cap 7 is extended in height to pass through the housing cap 19. Thus, the housing cap 19 serves as a guide bushing for the valve body cap 7. The height of the extended valve body cap 7 should be sufficient so that it never drops below the lower surface of the housing cap 19. This way, since the housing cap 19 is affixed to the valve housing 1, the valve body 2 cannot be withdrawn. In use, the valve housing 1 port is connected to a forced fluid (air, gas or liquid) source. When the valve is closed (FIG. 7), forced air directed into the port exerts pressure onto the end plate 4 and valve body 2, downward and open.

As above, the valve body cap 7 with collar 8 (and valve body 2) slide downward until the collar 8 abuts the shoulder 13 in the port of valve housing 1. This extends the endplate 4 beneath the valve body 1 opening the ports 3a for fluid flow (air, gas or liquid). Again, the barrel space between the shoulder and the collar 8 defines the first “control volume” 20A. The shoulder 13 limits downward motion of the cap 7/collar 8 and body 2, and seats the valve body cap 7 and collar 8 when the valve is in the open (down) position. The first control volume 20A in FIG. 6 is near zero because the valve is shown in an open position, but the first control volume 20A increases (FIG. 7) as the valve closes. For the two-way valve, a second control volume 20B of the valve body 2 is defined within the barrel by the upper surface of the collar 8 and the lower surface of the housing cap 19. The second control volume 20B in FIG. 6 is near maximum because the valve is shown in an open position, but the second control volume 20B decreases (FIG. 7) as the valve closes. In the preferred embodiment, the maximum vertical extent of the control volumes 20A, 20B of the valve body 2 are approximately equal to one-half the length of the valve body 2.

In either one-way or two-way valve operation, a return spring may be loaded into the valve body 2, possibly but not necessarily one side or the other of the collar 8, to bias the valve member back to either open or closed positions, further improving response time.

Generally, a forced air distribution system with electronic solenoids or piezo-electric valves will be used to control the disclosed valve. For example, compressed air is input through a one-way valve to prevent losses due to back pressure. A programmable electronic control module manages the distribution and timing of the flow of forced air as needed. The air may be forwarded through a manifold and thereby gated through to a plurality of the valves according to the present invention. The gates may be solenoids or piezo-electric valves under control of the programmable electronic control module. Those skilled in the art will recognize that a variety of conventional electronic, electromechanical, electromagnetic and piezo air distribution schemes exist and are considered standard equipment for fluid actuated valve systems.

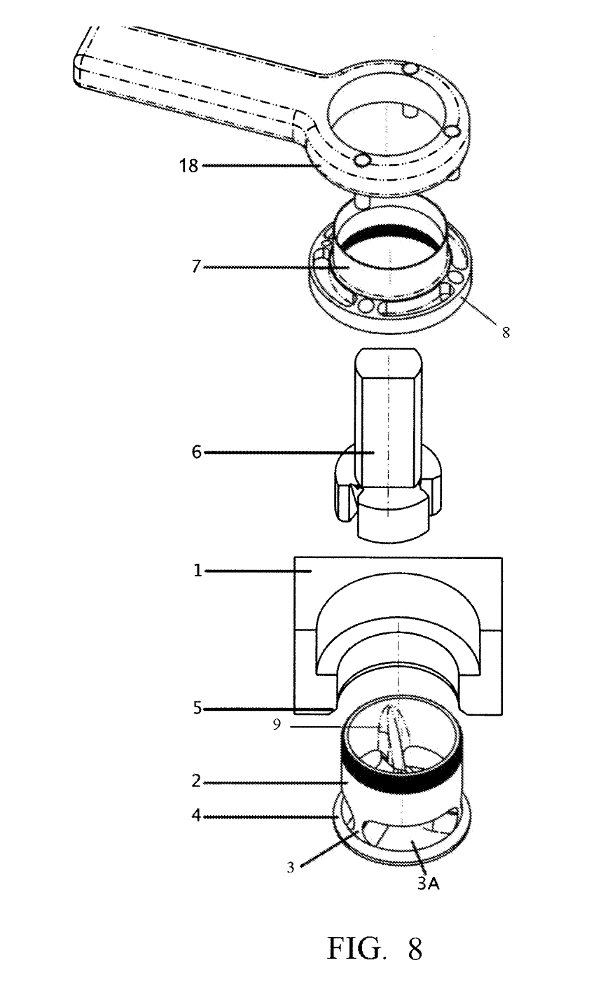

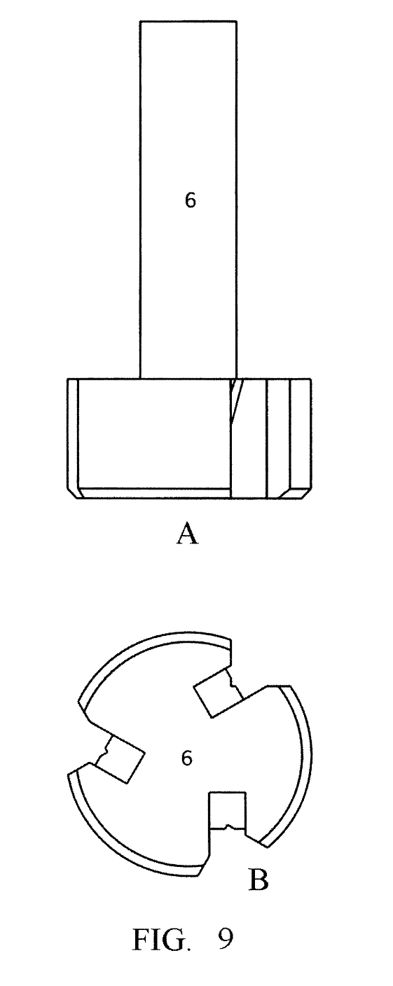

The above-described valve confers another advantage in that its design greatly facilitates installation and removal. In the context of the embodiment shown in FIGS. 1-5, FIG. 8 illustrates this premise with a unique valve wrench 18 designed to mate with the collar 8 of valve body cap 7, and a chuck 6. For this purpose, the upward-facing surface of the collar 8 is defined by a series of interlocking features such as apertures (as shown), notches or protuberances. The valve wrench 18 is defined by an elongate handle for manual turning, and an open circular head likewise adorned with a cooperating series of interlocking features such as posts (as shown) to fit into the apertures of the collar 8 of valve body cap 7, or notches or other protuberances, etc.

FIG. 9 is an enlarged side (A) and bottom (B) view of the chuck 6. The chuck 6 includes an extended stem leading to a disk defined by a series of notches. The stem is defined by a keyed cross-section as shown. The chuck 6 is intended to maintain the valve body 2 stationary while the valve body cap 7 and collar 8 are removed, and the chuck 6 is inserted downwardly into the valve body 2. The notches in chuck 6 conform to the interior vanes 9 and grip the vanes 9 such that maintaining the chuck stationery holds the valve body 2 stationary. The valve wrench 18 is inserted over the chuck 6 with the chuck 6 protruding upward through the open valve wrench 18. The cooperating series of interlocking features (posts or otherwise) fit into the apertures of the collar 8 and provide turning leverage. Since the chuck 6 protrudes upward through the open valve wrench 18, a standard wrench may be used to maintain the chuck 6 stationery while the valve wrench 18 is turned to unscrew the valve body cap 7 and collar 8 from the valve body 2. This design greatly facilitates installation and removal.

The above-described embodiments of the present invention, inclusive of the fluid actuated valve itself, plus installation/removal wrench and chuck, solve the problems and eliminate the disadvantages associated with conventional direct valves. They provide an assembly that is simple and straightforward, fabricated of strong, durable, resilient materials appropriate to the nature of their usage, and may be economically manufactured and sold.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

### INDUSTRIAL APPLICABILITY

Directly operated, or actuated, fluidic valves are employed in a wide variety of manufacturing environments where high flow rates and fast response times are desired. Such valves are used in a wide variety of contexts ranging from engines to industrial systems to pneumatic tools. The operating parameters for such systems are growing increasingly stringent as designers attempt to make them faster, less expensive and lightweight. This places increasing demands on the valves used for such systems. Manufacturers now require control valves that can provide extremely fast positive shutoff, and turn on, within a few milliseconds. This speed is very difficult to achieve in a fluid valve. Consequently, there would is significant industrial applicability for a direct fluid-actuated valve assembly that can provide extremely fast positive shutoff, and turn on, within a few milliseconds.

We claim:

1. A fluid actuated valve assembly, comprising:
a valve housing having a cylindrical fluid port defined by a larger upper chamber and a smaller lower chamber separated by an upwardly-facing shoulder;
a valve body seated in the valve housing, said valve body comprising
an integral hollow, cylindrical member bounded by an upper end, a lower end closed by an endplate, and a cylindrical sidewall defined by a plurality of open ports evenly spaced circumferentially adjacent the endplate, and a corresponding plurality of mullions between the ports, and
a plurality of vanes each extending from one of said plurality of mullions inward into said valve body, and each of said vanes being inclined to promote a circular internal fluid flow; and
a valve cap comprising an annular collar affixed to said upper end of said valve body;
said valve body and cap being slidable within said valve housing between an open position with said valve cap abutting said valve housing shoulder, and a closed position with said valve body endplate closing said valve housing port.

2. The fluid actuated valve assembly according to claim 1, wherein the smaller lower chamber of said valve housing opens outwardly from said valve housing at a beveled rim, and said valve body endplate is formed with a beveled peripheral edge to seat against the beveled rim of said valve housing.

3. The fluid actuated valve assembly according to claim 2, wherein said valve body endplate is formed with a 45 degree bevel.

4. The fluid actuated valve assembly according to claim 2, wherein said valve body endplate is formed with an incline running from said beveled peripheral edge to its center.

5. The fluid actuated valve assembly according to claim 4, wherein said incline is from 0 to 25 degrees.

6. The fluid actuated valve assembly according to claim 1, wherein said plurality of open ports consist of three uniformly oblong ports opening into the hollow interior of the valve body, and said plurality of mullions consist of three mullions formed in the cylindrical wall of the valve body between said ports.

7. The fluid actuated valve assembly according to claim 6, wherein a horizontal extent of each of said mullions is approximately 15% that of each port.

8. The fluid actuated valve assembly according to claim 6, wherein said plurality of vanes comprises three vanes each integrally formed with a corresponding mullion and each extending there from inward into said valve body.

9. The fluid actuated valve assembly according to claim 8, wherein each of said vanes originates proximate the upper end of the valve body and terminates at said endplate running lengthwise down a corresponding mullion for support.

10. The fluid actuated valve assembly according to claim 9, wherein each of said vanes is uniformly inclined to promote a circular internal fluid flow.

11. The fluid actuated valve assembly according to claim 9, wherein each of said vanes is uniformly inclined along a vertical y axis.

12. The fluid actuated valve assembly according to claim 11, wherein each of said vanes is uniformly inclined along a horizontal x axis.

13. The fluid actuated valve assembly according to claim 9, wherein each of said vanes flares outward toward a juncture at said endplate.

14. The fluid actuated valve assembly according to claim 13, wherein each of said vanes flares outward along a curvature toward the juncture at said endplate.

15. The fluid actuated valve assembly according to claim 10, wherein each of said vanes is defined by a rounded outermost edge.

16. The fluid actuated valve assembly according to claim 1, wherein said valve cap defines a first control volume relative to said valve housing shoulder.

17. The fluid actuated valve assembly according to claim 16, further comprising a housing cap affixed to said valve housing and defining a second control volume relative to said valve cap.

18. A toolset for installing and removing a fluid actuated valve assembly, said valve assembly comprising a valve housing having a cylindrical fluid port, a hollow cylindrical valve body seated in the port of said valve housing and defined by a plurality of vanes extending into the hollow interior of said valve body, and a valve cap defined as an annular collar affixed to said valve body, said toolset comprising: a valve wrench having an elongate handle for manual turning, and an open circular head defined by a plurality of interlocking keys for mating with the valve cap; and a chuck formed as an extended stem leading to a disk defined by a series of notches conforming to the vanes of said valve body to grip the vanes and stabilize said valve body.

19. A fluid actuated valve assembly, comprising:
a valve housing having a cylindrical fluid port defined by a larger upper chamber and a smaller lower chamber separated by an upwardly-facing shoulder;
a valve body seated in the valve housing, said valve body comprising
a hollow, cylindrical member bounded by an upper end, a lower end closed by an endplate, and a cylindrical sidewall defined by a three oblong ports evenly spaced circumferentially about said cylindrical sidewall proximate the endplate and opening into the hollow of said cylindrical member, and a corresponding plurality of mullions between the oblong ports, said mullions including a plurality of vanes extending interiorly into the hollow of said valve body, each of said vanes being vertically and horizontally inclined to promote a circular internal fluid flow within the hollow of said valve body; and
a valve cap comprising an annular collar affixed to said upper end of said valve body, both valve body and valve cap being slidable within said valve housing between an open position with said valve cap abutting said valve housing shoulder, and a closed position with said valve body endplate closing said valve housing port.
